(19) United States
(12) Patent Application Publication
(10) Pub. No.: US 2015/0278670 A1
(43) Pub. Date: Oct. 1, 2015

(54) CHIP CARD AND METHOD FOR OPERATING A CHIP CARD

(71) Applicant: Infineon Technologies AG, Neubiberg (DE)

(72) Inventors: Peter Laackmann, Munich (DE); Marcus Janke, Munich (DE)

(21) Appl. No.: 14/673,901

(22) Filed: Mar. 31, 2015

(30) Foreign Application Priority Data
Mar. 31, 2014 (DE) 10 2014 104 489.4

(51) Int. Cl. G06K 19/06

(52) U.S. Cl. CPC G06K 19/06206

(57) ABSTRACT

In various embodiments, a chip card is provided. The chip card includes a chip having a memory unit and a control unit, and a coil which is electrically coupled to the control unit and is intended to generate a magnetic field. The control unit and the coil may be set up to simulate a magnetic strip using the generated magnetic field.

### CROSS-REFERENCE TO RELATED APPLICATION

This application claims priority to German Patent Application Serial No. 10 2014 104 489.4, which was filed Mar. 31, 2014, and is incorporated herein by reference in its entirety.

### TECHNICAL FIELD

Various embodiments relate generally to a chip card and to a method for operating a chip card.

### BACKGROUND

In a conventional chip card, data are stored in one or more memory elements of the chip card. The data may be at least partially stored in the memory elements and/or read from the latter using a control unit of a chip of the chip card. The data can therefore be stored on the chip card in a changeable manner. In particular, the data can be changed using the control unit of the chip card. Alternatively, chip cards which have a read-only memory (ROM) are also known. A chip card may be set up in such a manner that it can actively defend itself against access to the data and/or a change and/or can prevent this or can allow it at least only after a code, a PIN (Personal Identification Number) or the like has been input.

In a conventional magnetic strip card, data are coded in a static magnetic field of a magnetic strip and are stored in the magnetic strip of the magnetic strip card. The data cannot be changed by the magnetic strip card itself and the magnetic strip card therefore carries virtually static data. The data can be changed only using an external apparatus. Furthermore, a magnetic strip card cannot actively defend itself against access to the data and/or a change of the data. Magnetic strip cards can fundamentally be read at any time, as a result of which the data can be accessed, and/or the data can fundamentally be changed at any time.

Magnetic strip cards are increasingly being replaced with chip cards, for example credit cards or EC cards. However, it is often not possible to dispense with the magnetic strip since there are many reading apparatuses for magnetic strip cards which are often still intended to be used.

For these reasons, a chip and a magnetic strip were integrated in a single card. Data which can be changed using the chip can therefore be stored on the card and the card can be easily read using the magnetic strip. However, a discrepancy between the data stored on the chip and the data stored in the magnetic strip may now arise when changing the data on the chip.

### SUMMARY

In various embodiments, a chip card is provided. The chip card includes a chip having a memory unit and a control unit, and a coil which is electrically coupled to the control unit and is intended to generate a magnetic field. The control unit and the coil may be set up to simulate a magnetic strip using the generated magnetic field.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a conventional chip card;

FIG. 2 shows a conventional chip card;

FIG. 3 shows a conventional chip card;

FIG. 4 shows an embodiment of a chip card;

FIG. 5 shows an embodiment of a voltage profile for simulating a magnetic field of a magnetic strip; and

FIG. 6 shows a flowchart of an embodiment of a method for operating a chip card.

### DESCRIPTION

The following detailed description refers to the accompanying drawings which form part of this description and which show, for the purpose of illustration, specific embodiments in which the invention can be implemented. In this respect, direction terminology such as “at the top”, “at the bottom”, “at the front”, “at the rear”, “front”, “rear”, etc. is used with reference to the orientation of the described figure(s). Since components of embodiments can be positioned in a number of different orientations, the direction terminology is used for illustration and is not restrictive in any way. It goes without saying that other embodiments can be used and structural or logical changes can be made without departing from the scope of protection of the present invention. It goes without saying that the features of the different embodiments described herein can be combined with one another unless specifically stated otherwise. The following detailed description should therefore not be interpreted in a restrictive sense, and the scope of protection of the present invention is defined by the enclosed claims.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Within the scope of this description, the terms “connected”, “linked” and “coupled” are used to describe both a direct and an indirect connection, a direct or indirect link and direct or indirect coupling. In the figures, identical or similar elements are provided with identical reference symbols if this is expedient.

Various embodiments provide a chip card which can store data in such a manner that the data can be changed with the aid of the chip card and the data and/or changed data can be easily read, e.g. with the aid of a magnetic strip reader.

Various embodiments provide a method for operating a chip card, which method can be used to represent data stored in a changeable manner on the chip card in such a manner that the data and/or the changed data can be easily read, e.g. with the aid of a magnetic strip reader.

Various embodiments provide a chip card. The chip card has a chip having a memory unit and a control unit. A coil of the chip card is electrically coupled to the control unit. The coil is used to generate a magnetic field. The control unit and the coil are set up to simulate a magnetic strip using the generated magnetic field.

In other words, the control unit and the coil can be used to simulate the magnetic field of a magnetic strip in such a manner that it represents the data. This makes it possible to read the data stored in a changeable manner on the chip card using a conventional magnetic strip card reader. The coil can be fitted to the chip instead of the magnetic strip. The magnetic field can be generated, for example, by alternately controlling the coil. This field may simulate the contents of a magnetic strip for a reading head in the card terminal of the magnetic strip card reader. A magnetic strip is therefore simulated on a chip card. This may make it possible, for example, to represent changeable data by simulating the magnetic strip. For example, transaction-specific numbers can be generated. The memory unit may be set up to store data, for example. The control unit may be set up to write data to the memory unit and/or to read data from the memory unit, for example. The data may be, for example, any type of information, for example personal data, computer code, system data, public data, etc.

In various embodiments, the control unit and the coil are set up to generate the magnetic field in such a manner that the magnetic field is representative of at least one part of the data stored in the memory unit. For example, the data may be stored in a partially changeable manner and in a partially unchangeable manner. The magnetic field may be representative of the changeable and/or unchangeable data.

In various embodiments, the control unit and the coil are set up to generate the magnetic field as an alternating magnetic field.

In various embodiments, the control unit has a magnetic strip simulation unit. The magnetic strip simulation unit is electrically coupled to the coil. The magnetic strip simulation unit is set up to determine at least one signal profile on the basis of the part of the data, which signal profile is representative of the part of the data, and to generate at least one electrical signal on the basis of the determined signal profile and to provide the coil with the generated electrical signal.

The signal profile may be, for example, an analog or digital signal profile. For example, the signal profile may be representative of a sequence of digital information. The electrical signal may have, for example, one or more electrical voltages and/or one or more electrical currents.

In various embodiments, the coil is in the form of a strip.

In various embodiments, the coil is arranged in a magnetic strip region of the chip card. The magnetic strip region is, for example, the region in which the magnetic strip is arranged in a conventional magnetic strip card.

In various embodiments, the chip card has an additional coil which is electrically coupled to the control unit. The control unit and the additional coil are set up to generate a second magnetic field for contactlessly transmitting data. For example, the additional coil may be used to transmit the data using RFID. Alternatively or additionally, the antenna may be designed and/or used to transmit energy for operating the chip card, e.g. the chip.

Various embodiments provide a method for operating a chip card. In this case, the magnetic field is generated, with the aid of the control unit of the chip of the chip card and the coil of the chip card that is electrically coupled to the control unit, in such a manner that the magnetic strip, in particular of a conventional magnetic strip card, is simulated using the generated magnetic field.

In various embodiments, a chip card may be a smartcard or an integrated circuit card (ICC). The chip card may be controlled and/or read, for example, using an external apparatus, for example a card reader and/or an external terminal. The chip card is suitable, for example, for interacting and/or for carrying out interaction with the external apparatus. In various embodiments, the interaction includes, for example, communication and/or initiation and/or performance of an authorization, an authentication and/or a payment process, for example, and/or releasing information and/or enabling access to a closed area, for example, the external apparatus being able to have, for example, a security lock, a point-of-sales terminal or a cash dispenser in various embodiments.

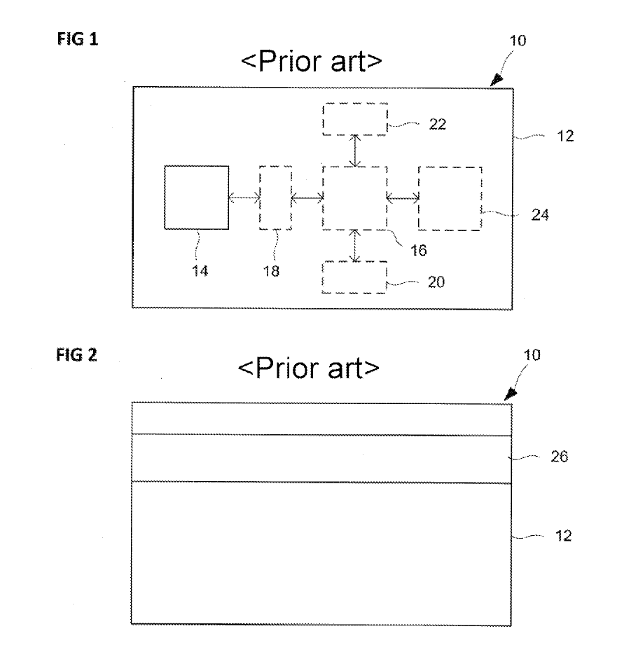

FIG. 1 shows a conventional chip card 10. In various embodiments, FIG. 1 shows a plan view of a front side of the conventional chip card 10. The conventional chip card 10 has a card body 12. The card body 12 is physically coupled to an electronic circuit. The electronic circuit may be entirely or partially integrated in a chip and/or die of the conventional chip card 10. The electronic circuit may have, for example, electrical contacts 14, a control unit 16, an input/output unit 18 and/or one, two or more memory elements 20, 22, 24.

The control unit 16, the input/output unit 18 and/or the memory elements 20, 22, 24 may be integrated in the card body 12 and/or may be integrated in fewer than the illustrated elements, for example in one, two or three chips of the conventional chip card 10, and/or fewer, more or alternative memory elements 20, 22, 24 may be arranged, which is why these elements and those elements are illustrated using dashed lines in FIG. 1.

The electrical contacts 14 are exposed on the front side of the conventional chip card 10 for making physical and electrical contact. The electrical contacts 14 are suitable for transmitting data from an external apparatus (not illustrated) to the conventional chip card 10 and/or from the conventional chip card 10 to the external apparatus. The input/output unit 18 may also have a transmitter (not illustrated), and the conventional chip card 10 may have an antenna (not illustrated in FIG. 1) for contactlessly transmitting data with the external apparatus. For example, the input/output unit 18 may be electrically coupled to the antenna. The antenna may be integrated in the card body 12, for example.

As memory elements 20, 22, 24, the conventional chip card 10 may have, for example, a read-only memory (ROM) 20, a random access memory (RAM) 22 and/or an electrically erasable programmable read-only memory (EEPROM) 24. The memory elements 20, 22, 24 may be set up to store data, for example.

The control unit 16 may be set up, for example, to store data on the RAM 22 or EEPROM 24 and/or to read data from the ROM 20, the RAM 22 and/or the EEPROM 24 and/or to process stored or transmitted data and/or to provide or transmit the data. The data may have, for example, contents of a code and/or account and/or authorization data relating to an owner of the conventional chip card 10. The control unit 16 may be set up, for example, to control the memory elements 20, 22, 24 and/or the input/output unit 18, to release data or to prevent data access and/or to control data interchange. For example, the electronic circuit may be set up to enable and/or prevent an authorization and/or payment process on the basis of a code. For example, the electronic circuit may be set up to check whether the external apparatus knows the code, for example by checking the data transmitted by the external apparatus.

FIG. 2 shows a conventional chip card 10. The conventional chip card 10 may largely correspond to the conventional chip card 10 explained above, for example. FIG. 2 shows, for example, a rear side of the conventional chip card 10. A magnetic strip 26 of the conventional chip card 10 is arranged on the rear side of the conventional chip card 10 in a magnetic strip region of the conventional chip card 10. The magnetic strip 26 is set up as a further memory element of the conventional chip card 10. The magnetic strip 26 generates a permanent static magnetic field. The magnetic field is formed in such a manner that data are coded in the magnetic field. The magnetic field of the magnetic strip 26 and therefore the data coded in the magnetic field can be changed with the aid of an external apparatus (not illustrated), for example the external apparatus mentioned above or another external apparatus. The magnetic strip 26 is not electrically coupled to the electronic circuit of the conventional chip card 10. The data stored in the magnetic strip 26 cannot be read, written or changed with the aid of the electronic circuit.

The magnetic strip 26 may be, for example, a high-coercivity magnetic strip (HiCo) or a low-coercivity magnetic strip (LoCo). These differ in terms of the magnetic flux density with which they can be written to. The LoCo is the common standard and is written to with a magnetic flux density in the region of 30 mT. The data written in this manner can be easily and/or inadvertently erased by external magnetic field effects. The HiCo is written to with a magnetic flux density in a range of 275 to 400 mT. Inadvertent erasure of the data written in this manner is virtually excluded. The data can therefore be changed only using special magnetic heads.

The magnetic strip 26 may be designed, for example, according to the ISO standard 7811. According to this standard, the magnetic strip 26 has a storage capacity of approximately 1024 bits on three tracks. Tracks 1 and 2 are specified only for read operation, and data can be read and written on track 3.

A bi-phase mark code (a.k.a. two-frequency coherent phase) can be selected, for example, as the coding and/or the method for storing the data in the magnetic strip 26. “Normal” writing with zeros and ones is regularly not possible since magnetization during writing is carried out only by level changes, but not by constant levels. In addition, it should be possible to swipe the conventional chip card 10 through an external reading apparatus at variable speeds. Swipe readers, in which the conventional chip card 10 is swiped, and space readers, in which the conventional chip card 10 is arranged in a stationary manner at a predefined location, are available as external reading apparatuses. Another difference is that the magnetic coding is read in swipe readers and the magnetic field is read in space readers.

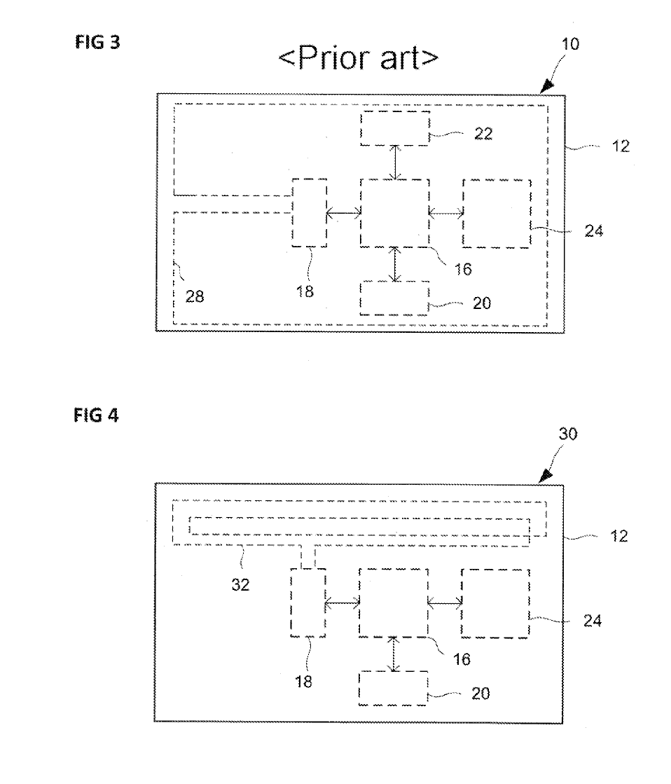

FIG. 3 shows a conventional chip card 10. The conventional chip card 10 may largely be designed according to the conventional chip card 10 explained above, for example. As an alternative or in addition to the electrical contacts 14, the conventional chip card 10 may have an antenna 28. The antenna 28 may be formed, for example, by a coil. The antenna 28 is used to contactlessly transmit data, for example using RFID. The antenna 28 may be electrically coupled to the transponder of the input/output unit 18, for example. Alternatively or additionally, the antenna 28 may be designed and/or used to transmit energy for operating the chip card 10, for example for operating the chip and/or the electronic circuit.

FIG. 4 shows an embodiment of a chip card 30. The chip card 30 has the card body 12. The card body 12 is physically coupled to the electronic circuit. The electronic circuit may be entirely or partially integrated in the chip and/or die of the chip card 30. The electronic circuit may have, for example, electrical contacts 14 (not illustrated in FIG. 4), the control unit 16, the input/output unit 18 and/or a memory unit having one, two or more memory elements 20, 22, 24.

The control unit 16, the input/output unit 18 and/or the memory elements 20, 22, 24 may be integrated in the card body 12 and/or may be integrated in fewer than the illustrated elements, for example in one, two or three chips, and/or fewer, more or alternative memory elements 20, 22, 24 may be arranged, which is why these elements and those elements are illustrated using dashed lines in FIG. 4.

According to the conventional chip card 10 illustrated in FIG. 1, the electrical contacts 14 may be exposed on the front side of the chip card 30 for making physical and electrical contact. The electrical contacts 14 are suitable for transmitting data from the external apparatus to the chip card 30 and/or from the chip card 30 to the external apparatus. The input/output unit 18 may also have the transmitter and the chip card 30 may have the antenna 28 (illustrated in FIG. 3) for contactlessly transmitting data with the external apparatus. For example, the input/output unit 18 may be electrically coupled to the antenna 28. The antenna 28 may be integrated in the card body 12, for example. The antenna 28 is used to contactlessly transmit data, for example using RFID.

As memory elements 20, 22, 24, the chip card 30 may have, for example, the read-only memory (ROM) 20, the random access memory (RAM) 22 and/or the electrically erasable programmable read-only memory (EEPROM) 24. The memory elements 20, 22, 24 may be set up to store data, for example.

The control unit 16 may be set up, for example, to store data on the RAM 22 or EEPROM 24 and/or to read data from the ROM 20, the RAM 22 and/or the EEPROM 24 and/or to process stored or transmitted data and/or to provide or transmit the data. The data may have, for example, contents of a code and/or account and/or authorization data relating to an owner of the chip card 10. The control unit 16 may be set up, for example, to control the memory elements 20, 22, 24 and/or the input/output unit 18, to release data or to prevent data access and/or to control data interchange. For example, the electronic circuit may be set up to enable and/or prevent an authorization and/or payment process on the basis of a code. For example, the electronic circuit may be set up to check whether the external apparatus knows the code, for example by checking the data transmitted by the external apparatus.

The chip card 30 has a coil 32, for example a first coil. The coil which forms the antenna 28 can be referred to as a second coil or an additional coil in this context. The coil 32 is electrically coupled to the input/output unit 18. The coil 32 may be formed, for example, substantially in the magnetic strip region in which the magnetic strip 26 is formed in the conventional chip card 10. The fact that the coil 32 is formed substantially in the magnetic strip region may mean, for example, that the coil 32 is arranged completely in the magnetic strip region, partially in the magnetic strip region, in a manner overlapping the magnetic strip region and/or in the magnetic strip region in one of the inner layers of the layer structure of the chip card 30, that is to say at a distance from the front side and the rear side of the chip card 30. The coil 32 may be in the form of a strip, for example. As an alternative to the second coil, e.g. the antenna 28, the first coil 32 may be designed and/or set up in such a manner that it is suitable and/or can be used for contactlessly transmitting data with the external apparatus and/or for transmitting the energy.

The coil 32 may be arranged in addition or as an alternative to the magnetic strip 26. If the coil 32 and the magnetic strip 26 are arranged, the coil 32 and the magnetic strip 26 may be arranged in different regions of the chip card 30, with the result that their magnetic fields do not influence one another in an unfavorable manner.

A magnetic field can be generated with the aid of the coil 32, the input/output unit 18 and/or the control unit 16 in such a manner that it corresponds to and/or simulates the magnetic field of the magnetic strip 26. In other words, a further memory element, to be precise the magnetic strip 26, of the chip card 30 can be simulated with the aid of the coil 32. The magnetic field of the coil 32 can be generated in such a manner that data are coded in the magnetic field. The magnetic field of the coil 32 and therefore the data coded in the magnetic field can be changed with the aid of the electronic circuit of the chip card 30.

A HiCo or LoCo magnetic strip, for example, can be simulated with the aid of the coil 32. The magnetic field can be generated, for example, in such a manner that it simulates the magnetic field of the magnetic strip 26 according to the ISO standard 7811.

A bi-phase mark code (a.k.a. two-frequency coherent phase) can be simulated, for example, as the coding of the data in the magnetic field. The data are coded in such a manner that it is possible to read the data by swiping the chip card 30 through a swipe reader at variable speed and/or by arranging the chip card 30 in a stationary manner on a space reader. In other words, the magnetic field can be simulated in such a manner that the magnetic coding and/or the magnetic field can be read.

In other words, the magnetic strip 26 can be simulated using the control unit 16 and the coil 32 in such a manner that the magnetic strip represents the data. This makes it possible to read the data which are stored in a changeable manner on the chip card 30 using a conventional magnetic strip card reader. The coil 32 can be fitted and/or introduced to the chip card 30 instead of the magnetic strip 26. The magnetic field can be generated, for example, by alternately controlling the coil 32. This field may simulate the contents of a magnetic strip 26 for a reading head in the card terminal of the magnetic strip card reader. The magnetic strip 26 is therefore simulated on the chip card 30. This may make it possible, for example, to represent changeable data by simulating the magnetic strip 26. Transaction-specific numbers can be generated, for example.

The control unit 16 and the coil 32 may be set up in such a manner that they generate the magnetic field such that the magnetic field is representative of at least one part of the data stored in the memory unit. For example, the data may be stored in a partially changeable manner and in a partially unchangeable manner. The magnetic field may be representative of the changeable and/or unchangeable data. The magnetic field may be generated as an alternating magnetic field, for example.

In order to simulate the magnetic strip 26, the control unit 16 may have a magnetic strip simulation unit (not illustrated), for example. If necessary, the magnetic strip simulation unit is electrically coupled to the coil 32. If necessary, the magnetic strip simulation unit is set up to determine at least one signal profile on the basis of the part of the data, which signal profile is representative of the part of the data, and to generate at least one electrical signal on the basis of the determined signal profile and to provide the coil 32 with the generated electrical signal. The signal profile may be an analog or digital signal profile, for example. The signal profile may be representative of a sequence of digital information, for example. The electrical signal may have, for example, one or more electrical voltages and/or one or more electrical currents.

As an alternative or in addition to directly electrically coupling the electronic circuit to the antenna 28, the electronic circuit may be electrically coupled to a third coil (not illustrated) and/or the third coil can then electromagnetically couple the electronic circuit to the antenna 28. In this case, the antenna 28 may be arranged on the card body 12 or may be arranged separately from the latter. This may also be referred to as a “booster” or “coupling system” and the antenna 28 may then be referred to as a booster antenna.

The chip card 30 may therefore clearly be free of a magnetic strip in various embodiments.

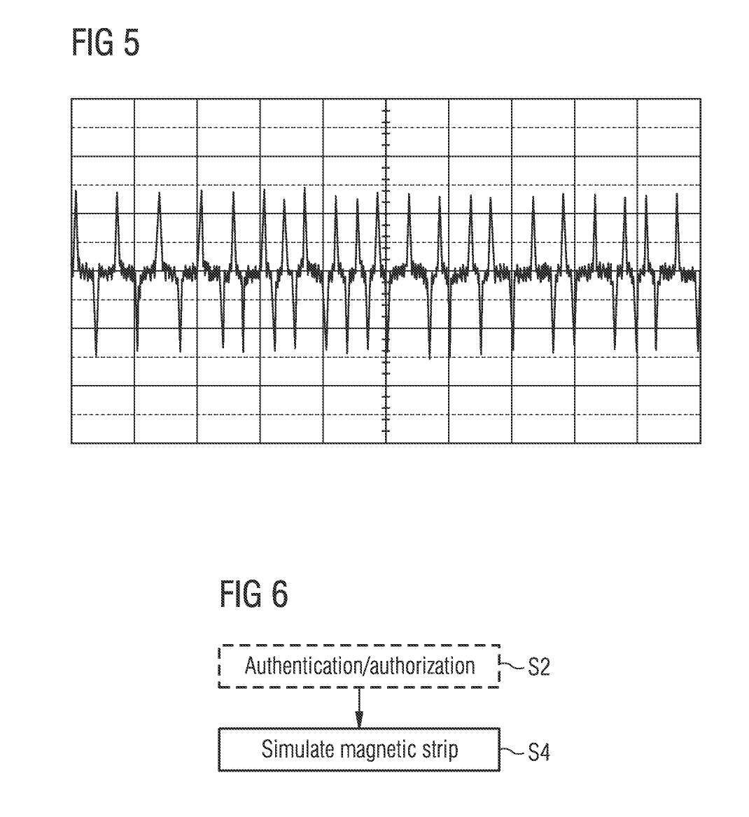

FIG. 5 shows an embodiment of a voltage profile for simulating the magnetic field of the magnetic strip 26. A voltage having the illustrated voltage profile is applied to the coil 32 at least while the chip card 30 is being swiped through a magnetic card reader, with the result that the corresponding data or information is/are transmitted to the reading head of the magnetic card reader. The illustrated voltage profile corresponds to the voltage profile which would prevail at the reading coil if the magnetic strip 26 with the corresponding magnetic coding were to be pulled past the reading coil.

The data may be coded, for example, according to a bi-phase mark code. Two line states are transmitted for each bit of data. A state change is carried out at the start of a bit. The coding on the line then differs, for example, as follows: in the case of a 1, the state changes in the center of the bit and, in the case of a 0, the state remains the same until the end of the bit. The data stored on the conventional magnetic strip 26 and the corresponding data transmitted using the simulated magnetic strip can be coded, for example, using the bi-phase mark code according to the ISO/IEC 7811 standard.

The data are generally stored on chip cards according to the ISO standard in such a manner that the swipe speed when reading the cards can vary and an item of clock information is accommodated on the card. The clock information is written to the card using a frequency-modulated signal, that is to say a signal whose polarity changes continuously at the clock rate of the data. Depending on how quickly the polarity is changed in succession, either a 1 or a 0 has been written. In the ISO standard, it has been agreed that the single frequency codes a 0 and the double frequency codes a 1. In practice, this may be implemented, for example, in such a manner that some zeros are coded at the beginning of each magnetic strip. As the magnetic strip 26 is swiped, the signal induced at the reading head is observed. The first signal changes are representative of the 0, as a result of which the single frequency is known. The first 1 arises at any time in the signal. This can be detected since it is coded by two polarity changes in quick succession. The fact that a change has taken place is detected by a short voltage peak at the reading head since only a changing magnetic field induces a voltage according to the law of induction. These voltage changes and voltage peaks can also be discerned in the voltage profile illustrated.

FIG. 6 shows a flowchart of an embodiment of a method for operating a chip card, for example the chip card 30 explained above.

In an optional step S2, authentication and/or authorization for access to the chip card 30 and/or for access to an external apparatus can be effected with the aid of the chip card 30. For example, it is possible to check whether data can be read from the chip card 30 using an external reading apparatus and/or whether data can be stored on the chip card 30 using an external writing apparatus and/or whether data stored on the chip card 30 can be changed using an external writing apparatus and/or whether the external apparatus can be accessed using the chip card 30. Depending on the check, the corresponding access to the chip card 30 and/or to the data stored on the latter and/or to the external apparatus can then be enabled or prevented.

If step S2 is carried out, a step S4 can be executed if enabled. If step S2 is not carried out, step S4 can be directly executed.

In step S4, the magnetic strip 26 of the conventional chip card 10 is simulated using the coil 32 of the chip card 30, e.g. without a magnetic strip 26 actually being present. For example, the magnetic field is generated, with the aid of the control unit 16 of the chip of the chip card 30 and the coil 32 of the chip card 30 that is electrically coupled to the control unit 16, in such a manner that the magnetic strip 26 is simulated using the generated magnetic field. For this purpose, the voltage having the voltage profile shown in FIG. 5 is applied to the coil 32, for example.

The invention is not restricted to the embodiments stated. For example, the electronic circuit of the chip card 30 may have more or fewer electronic components 14, 16, 18, 20, 22, 24 and/or more or fewer chips or dies. Furthermore, the method for operating the chip card 30 may have more or fewer steps. For example, steps S2 and/or S4 may each have two or more substeps which can each be carried out at the same time and/or in succession and/or in a temporally overlapping manner.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A chip card, comprising:
a chip having a memory unit and a control unit; and
a coil which is electrically coupled to the control unit and is intended to generate a magnetic field;
the control unit and the coil being set up to simulate a magnetic strip using the generated magnetic field.

2. The chip card of claim 1,
the control unit and the coil being set up to generate the magnetic field in such a manner that the magnetic field is representative of at least one part of the data stored in the memory unit.

3. The chip card of claim 1,
the control unit and the coil being set up to generate the magnetic field as an alternating magnetic field.

4. The chip card of claim 2,
wherein the control unit has a magnetic strip simulation unit which is electrically coupled to the coil and is set up to determine at least one signal profile on the basis of the part of the data, which signal profile is representative of the part of the data, and to generate at least one electrical signal on the basis of the determined signal profile and to provide the coil with the generated electrical signal.

5. The chip card of claim 1,
wherein the coil is in the form of a strip.

6. The chip card of claim 1,
wherein the coil is arranged in a magnetic strip region of the chip card.

7. The chip card of claim 1, further comprising:
an additional coil which is electrically coupled to the control unit;
the control unit and the additional coil being set up to generate a second magnetic field for at least one of contactlessly transmitting data or transmitting energy for operating the chip card.

8. The chip card of claim 1,
wherein the control unit and the coil are set up to generate a second magnetic field for at least one of contactlessly transmitting data or transmitting energy for operating the chip card.

9. A method for operating a chip card, comprising:
providing a chip card;
generating a magnetic field, with the aid of a control unit of a chip of the chip card and a coil of the chip card that is electrically coupled to the control unit, in such a manner that a magnetic strip is simulated using the generated magnetic field.
